(19) United States
(12) Patent Application Publication
(10) Pub. No.: US 2009/0289118 A1
(43) Pub. Date: Nov. 26, 2009

(54) Card reader integrated with touch button control and control chip module thereof

(76) Inventors: Chi-Tung Chang, Taipei (TW); Shih-Min Lan, Taipei (TW); I-Chieh Lin, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/153,457

(22) Filed: May 20, 2008

(51) Int. Cl. G06K 7/06

(52) U.S. Cl. 235/441

(57) ABSTRACT

A card reader integrated with touch button control, which is applicable in an application system, the said card reader comprises: a touch sensing interface, at least a memory card interface, an interface connection unit and a control chip memory. Herein the touch sensing interface consists of plural touch buttons, and the memory card interface is used to connect a memory card. Furthermore, the interface connection unit is connected to a system connection unit of the application system; the control chip module is connected to the touch sensing interface and the memory card interface, and, in terms of the touch sensing interface and the memory card interface, respectively uses different specification of device class to build the connection with the application system in order to perform signal transmission. The card reader is thereby enabled to achieve the objectives of providing features of controlling touch buttons and accessing memory cards.

### BACKGROUND OF THE INVENTION

1. Field of the Invention

The present invention relates to a card reader; particularly, to a card reader integrated with touch button control and control chip module thereof.

2. Description of Related Art

Information technologies is a fast pace developing field, and computer systems have gradually become a tools that is sine qua non for users in their daily lives or works. Whether it is desktop computer, notebook computer or even Personal Digital Assistant (PDA), the host devices thereof all provide several control buttons or function keys (e.g. for multimedia player control), allowing users to control the operations of computers in a more direct and intuitive fashion.

On the other hand, look at the digital data storage portion in the computer system, since silicon-based storage media (such as Flash memory) provides the advantages in usability and flexibility of being light, small and slim, and also the range of applications for various memory cards becomes much wider than before, more and more computer systems gradually integrate therein a device with card reading function, via external connection means or built-in installation means, which facilitates users to more conveniently access memory cards used by themselves.

Taking the current notebook computer integrating the two above-mentioned functions for example, refer now to FIG. 1, wherein an architectural diagram of a prior art notebook computer is shown. As illustrated therein, the notebook computer 9 comprises a plurality of control buttons 91, a button control chip 92, a plurality of card connectors 93, a card reading control chip 94 and a central processing unit 95. The button control chip 92 is therein connected to the control buttons 91 via General Pins of Input/Output (GPIO), and further through an Inter-Integrated Circuit (I2C) or a Universal Serial Bus (USB) to be connected to the central processing unit 95. The button control chip 92 is used to set up the definition (i.e. define what the control button does, like multimedia player control) of each control button 91, and when any of the control buttons 91 is triggered, it issues the corresponding signal to the central processing unit 95. Additionally, the card reading control chip 94 is connected to various memory cards (not shown) through the plurality of card connector 93 to access data, and is also further connected to the central processing unit 95 via the Universal Serial Bus for data transmissions.

However, for the architecture of the currently designed notebook computer 9, since the designs of the button control chip 92 and the card reading control chip 94 are independent, thus, in terms of the central processing unit 95, it has to simultaneously control the button control chip 92 and the card reading control chip 94 to perform respective access actions, causing a reduction in execution performance of the central processing unit 95. Furthermore, on the design of the notebook computer 9, it has to take the design parameters of both the button control chip 92 and the card reading control chip 94 in the central processing unit 95 into consideration, which may lead to difficulties in circuit layout arrangement.

Also, if an independent card reader is accessorized via installation in the notebook computer 9, similar to the components of the card reader related with the card reading control chip 94 and the card connectors 93 shown in FIG. 1 which are independently designed on another circuit board, then it is impossible to effectively further miniaturize the size of the computer due to their independent design nature. In addition, for a desktop computer, it is common to design a built-in card reader thereon to allow integration, whereas in the area of control for control buttons or function keys with the card reader, it is usually not integrated, and another alternative circuit board would have to be configured to be placed on the panel of computer case. As such, design cost for system manufacturers will inevitably increase.

Therefore, it is desirable to resolve the issues of providing more functions in a computer system, meanwhile still being able to maintain original execution efficiency, and at the same time further offer features of convenience and flexibility on application designs as well as advantages for reductions in both product size and cost.

### SUMMARY OF THE INVENTION

In view of the aforementioned descriptions, the issues that the present invention intends to address are to integrate the feature of touch button control through a control chip module in a card reader, such that the card reader can not only provide the function of memory card access, but offer the capability of control touch button. Thus, the application system co-operationally installed with the card reader according to the present invention needs not to significantly modify the design of hardware circuit therein, or even need not alter the circuit design at all, to conveniently and successfully accomplish the purpose of integrated design for both card reading function and touch button control function.

To achieve the above-described purposes, a solution proposed by the present invention provides a card reader integrated with touch button control, which can be employed in an application system, in which the said card reader comprises: a touch sensing interface, at least one memory card interface, an interface connection unit and a control chip module. The touch sensing interface has plural touch buttons, the memory card interface is used to connect a memory card, and the interface connection unit is connected to a system connection unit in the application system. Finally, the control chip module is connected to the touch sensing interface and the memory card interface, and, in terms of the touch sensing interface and the memory card interface, it respectively uses a different specification of device class to build connections with the application system for performing signal transmissions.

To achieve the above-described purposes, another solution (second embodiment) proposed by the present invention which provides a control chip module of the card reader integrated with touch button control, wherein the said card reader comprises a touch sensing interface, at least one memory card and an interface connection unit, in which the control chip module consists of: a sensing unit, a sensing control circuit, a card interface unit, a signal processing unit and a universal serial bus processing unit. The sensing unit generates a button sensing signal based on the status of the touch sensing interface, the sensing control circuit is used to control the operation of the sensing unit, the card interface unit is connected to the memory card interface for transmitting a data signal to a memory card inserted into the memory card interface, and the signal processing unit is connected to the interface connection unit so as to perform signal conversion and transmission with an application system. Finally, the USB processing unit is used to control the actions of the card interface unit and the sensing control circuit in order to receive the data signal and the button sensing signal, and further to respectively use a different specification of device class to build connections with the application system for performing signal transmissions.

To achieve the above-described purposes, yet another solution (third embodiment) is proposed by the present invention which provides a control chip module of the card reader integrated with touch button control, wherein the said module is a multi-chip module, and card reader comprises a touch sensing interface, at least one memory card and an interface connection unit, in which the control chip module consists of: a button control chip and a card reading control chip. The button control chip is connected to the touch sensing interface, used to generate a button sensing signal based on the status of the touch sensing interface. The card reading control chip is connected to the button control chip and further comprises: a card interface unit, signal processing unit and a USB processing unit. The card interface unit is connected to the memory card interface for transmitting a data signal to a memory card inserted into the memory card interface, the signal processing unit is connected to the interface connection unit so as to perform signal conversion and transmission with an application system, and the USB processing unit controls the actions of the card interface unit and the sensing control circuit in order to receive the data signal and the button sensing signal, and also further uses the Mass Storage Device Class in the specification of USB for performing signal transmissions with the application system, and alternatively uses a Human Interface Device (HID) class to transfer the button sensing signal with the said application system.

Hence, the card reader integrated with touch button control according to the present invention may thereby, after the co-operational installation of the said card reader in the application system, not only access to the memory cards, but directly support the control over touch buttons.

In order to allow further understandings of the features and technical contents provided by the present invention, references are made to the following detailed descriptions and appended drawings; wherein the appended drawings are merely employed to present the references and illustrations of the present invention, not for imposing any restriction thereon.

### BRIEF DESCRIPTION OF THE DRAWINGS

FIG. 1 is an architectural diagram of a prior art notebook computer;

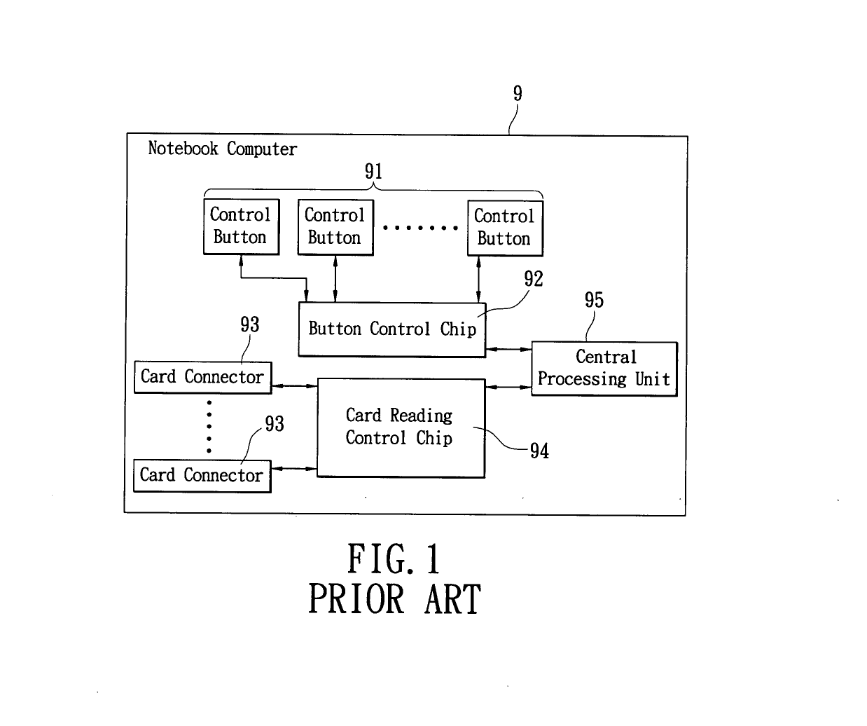

FIG. 2 is a block diagram of an embodiment for the card reader integrated with touch button control according to the present invention;

FIG. 3 shows a block diagram of a first embodiment for the control chip module of the card reader integrated with touch button control according to the present invention; and

FIG. 4 shows a block diagram of a second embodiment for the control chip module of the card reader integrated with touch button control according to the present invention.

### DETAILED DESCRIPTION OF THE PREFERRED EMBODIMENTS

The card reader integrated with touch button control according to the present invention integrates the function of touch button control through the control chip module in a card reader, which, in addition to the improvement over hardware design in the card read, may support compounded device class of Universal Serial Bus (USB) specification through the said control chip module, such that when performing touch button signal reception and memory card access, it respectively uses different device class to connect and communicate with the application system applied thereto. This allows the card reader to not only provide the function of memory card access, but further offer the capability of touch button control.

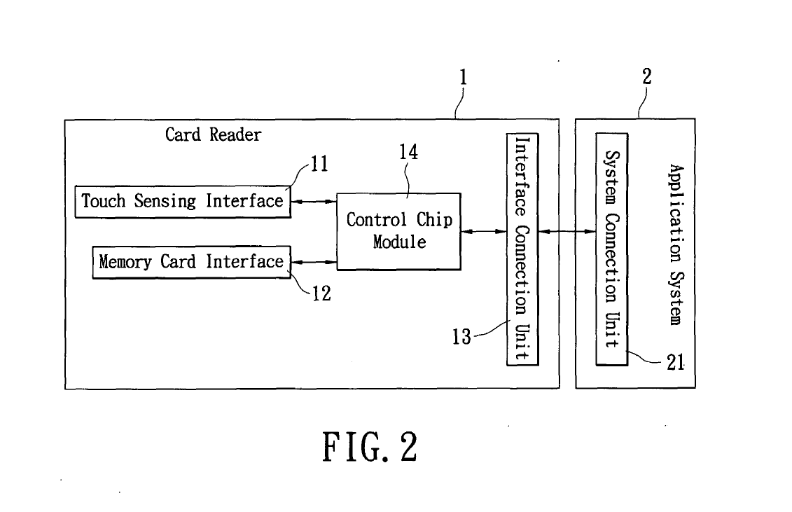

Referring now to FIG. 2, a block diagram of an embodiment for the card reader integrated with touch button control according to the present invention is shown. As illustrated in the Figure, the present embodiment provides a card reader 1, applied to an application system 2 (e.g. a notebook computer, a printer or a PDA and the like). In order to clearly distinguish respective hardware circuits contained in the card reader 1 and the application system 2, they are illustrated with external connection for describing the connection method in FIG. 2. Nevertheless, the card reader 1 may also be directly built-in or internally connected in the application system 2 as a whole.

The card reader 1 comprises: a touch sensing interface 11, at least one memory card interface 12, an interface connection unit 13 and a control chip module 14. The touch sensing interface 11 has plural touch buttons provided for users to press down, and each touch button may be individually defined as different control for various functions of the application system 2, hereby without any limit thereto. Additionally, the touch sensing interface 11, in design, may be of the type of capacitive touch control interface currently employed in a wide range of applications.

The memory card interface 12 is used to connect a memory card (not shown), and the memory card interface 12 can be for example a slot for supporting one single type of memory card, or else a slot for supporting multiple types of memory card (multiple-in-one slot, or universal slot). The interface connection unit 13 is provided to connect to a system connection unit 21 in the application system 2 through an internal or external connection, allowing the card reader 1 to perform connection and signal transmission with the application system 2.

The control chip module 14, in design, can be a single chip module or multi-chip module, and may be for example a chip module with USB feature or Peripheral Component Interconnection (PCI-Express) bus, for connecting the touch sensing interface 11 and the memory card interface 12. Also, in terms of the touch sensing interface 11 and the memory card interface 12, the control chip module 14 respectively uses different specification of device class to build connection with the application system 2 to perform signal transmissions. Herein, for the touch sensing interface 11, the control chip module 14 may employ an HID device class from USB specification to connect and perform signal transmissions with the application system 2; whereas on the other hand, in terms of the memory card interface 12, the control chip module 14 may alternatively use an Mass Storage Device Class in USB specification to connect and perform signal transmissions with the application system 2.

In other word, when the touch sensing interface 11 is pressed down by a user, then after the reception of the button signal at the control chip module 14, the transmission specification of the HID device class will be used to transfer the button signal to the application system 2; that is, for the application system 2, the card reader 1 at this moment is considered to be a Human-Machine interface device. Similarly, in case a user intends to access the data stored in a memory card and operates data signal access on the application system 2, the control chip module 14 will adopt the transmission specification defined in the Mass Storage Device Class to transfer the data signal; thus at this time, for the application system 2, the card reader 1 now is deemed to be a mass storage device.

Additionally, when the specification of PCI-Express is used to design the control chip module 14, the transmission protocol for USB that it supports will be further employed to achieve the objective of the present invention.

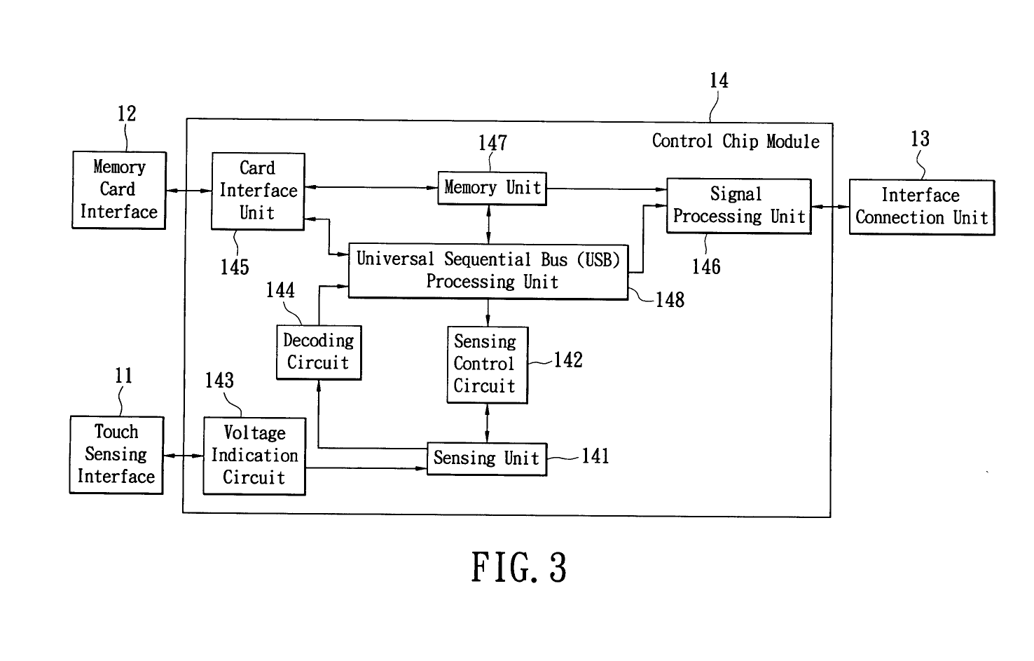

Refer now to FIG. 3, wherein a block diagram of a first embodiment for the control chip module of the card reader integrated with touch button control according to the present invention is shown. As illustrated, the present embodiment further discloses the detailed architecture of the control chip module 14 in the card reader 1, and the control chip module 14 of the present embodiment is designed by using single chip module; i.e., the control chip module 14 in the present embodiment is actually one single chip. The control chip module 14 provided in the present embodiment consists of: a sensing unit 141, a sensing control circuit 142, a voltage indication circuit 143, a decoding circuit 144, a card interface unit 145, a signal processing unit 146, a memory unit 147 and a USB processing unit 148.

Herein, the USB processing unit 148 is used to control the actions of the sensing control circuit 142, facilitating the sensing control circuit 142 to further control the operations of the sensing unit 141. The voltage indication circuit 143 is used to externally connect to the storage device 10, so as to provide the status of the storage device 10 to the sensing unit 141. Furthermore, the sensing unit 141 is connected to the voltage indication circuit 143, as so to generate a button sensing signal based on the status of the touch sensing interface 11. Among others, the design of the voltage indication circuit 143 can be for example based on a design of switch; that is, when a user presses down one of the touch buttons on the touch sensing interface 11, it can conduct the corresponding switch, such that the sensing unit 141 can receive the trigger signal of the said touch button, so as to further generate a button sensing signal.

Besides, in practical design, the voltage indication circuit 143 and the sensing unit 141 may be for example of a design of analog circuit, hence it is necessary to further connect to the sensing unit 141 via the design of the decoding circuit 144, in order to receive the button sensing signal to decode, and converts the button sensing signal from analog signal to digital signal, then afterward exports it to the USB processing unit 148, allowing the USB processing unit 148 to identify which touch button is actually pressed down by the user and to report the result to the application system 2.

Next, the card interface unit 145 on the control chip module 14 is used to externally connect to the memory card interface 12 and receives the control from the USB processing unit 148, so as to the perform data signal transfer with the memory card (not shown) inserted in the memory card interface 12.

The signal processing unit 146 is used to externally connect to the interface connection unit 13, in order to perform signal conversion and transmission with the application system 2. Herein, the signal processing unit 146 may consist of a Serial Interface Engine (SIE) (not shown) and a transceiver (UTMI: USB 2.0 Transceiver Macrocell Interface or PHY: Physical Layer Transceiver) (not shown), so as to perform processes such as coding, decoding, error correction, bit filling, conversion and reception/transmission on the serial signal. The button sensing signal and data signal received by the USB processing unit 148, hence, will both be transferred again to the application system 2 through the signal processing unit 146. Certainly, any command signal issued by the application system 2 to the control chip module 14 of the card reader 1 will be transferred to the USB processing unit 148 through the signal processing unit 146 as well.

The memory unit 147 is connected between the card interface unit 145 and the signal processing unit 146 and receives the control from the USB processing unit 148 for providing data and registering data. In practical design, the memory unit 147 may comprise such as a software program section (not shown) and a data registry section (not shown). Herein the software program section employs the design of Read-Only Memory (ROM), used to store parallel software programs during the operation of the USB processing unit 148; while the data registry section uses Random Access Memory (RAM) design to temporarily hold data signal transferred between the application system 2 and the card reader 1.

The major feature of the present embodiment is that, after the reception of button sensing signal and data signal by the USB processing unit 148, it will respectively use different specifications of device class to perform signal transmissions, in order to accomplish connection with the application system 2. In terms of the part of button sensing signal, the USB processing unit 148 uses HID class to transfer; whereas for the data signal, the USB processing unit 148 alternatively adopts Mass Storage Device Class to perform transmissions. As such, no matter under what condition in which the user is using the touch sensing interface 11 or the memory card interface 12, the application system 2 can still correctly identify the current device class in the card reader 1 to facilitate signal transmissions.

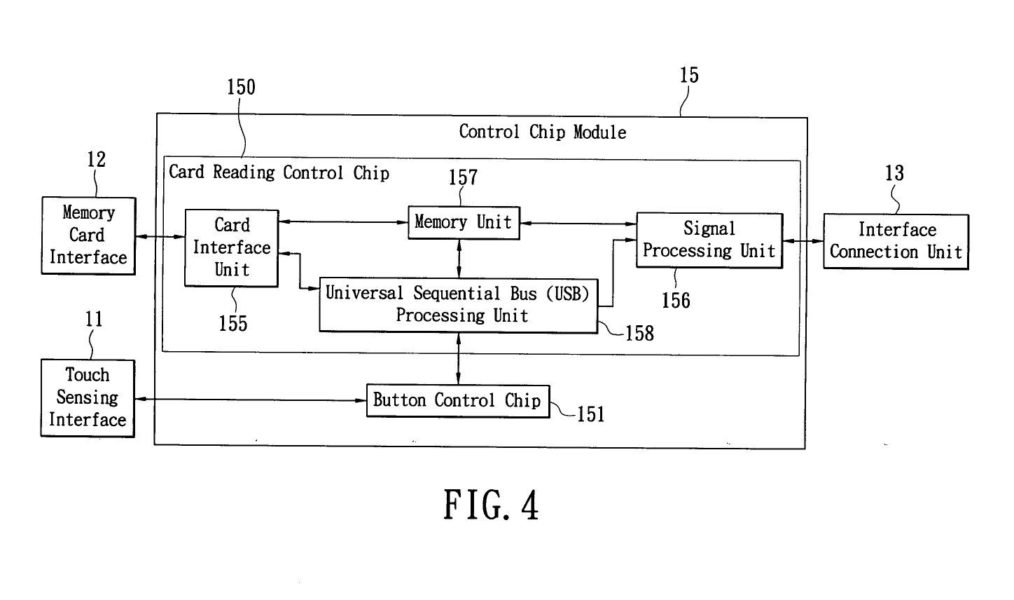

In addition, refer now to FIG. 4, wherein a block diagram of a second embodiment for the control chip module of the card reader integrated with touch button control according to the present invention is shown. The functions and operational principles are largely identical to the ones found in the first embodiment, but the major difference between the two is that the control chip module in the second embodiment adopts multi-chip module design. So as shown in FIG. 4, the control chip module 15 comprises: a card reading control chip 150 and a button control chip 151.

Herein the card reading control chip 150 simply consists of a card interface unit 155, a signal processing unit 156, a memory unit 157 and a USB processing unit 158. The operations of these said units are identical to the counterparts found in the first embodiment, thus further descriptions thereof are herein omitted. Regarding the unit without counterpart, the button control chip 151 is an alternatively independent control chip, used to sense the status of the touch sensing interface 11 for generating the button sensing signal.

Furthermore, in practical design, the button control chip 151 further connects to the card reading control chip 150 via an I2C connection (I2C is a multi-master serial computer bus), such that the button control chip 151 first transfers the generated button sensing signal to the USB processing unit 158 located in the card reading control chip 150, then the USB processing unit 158 controls according to the HID class to facilitate the signal transmission to the application system 2. In this way, it enables the card reader 1 co-operatively installed with the control chip module 15 to perform transmissions of both data signal and button sensing signal with the application system 2 through the identical interface connection unit 13.

In summary, the present invention integrates function of touch button control via control chip module in a card reader, so as to allow the card reader to not only has the feature of memory card access, but at the same time offer the function for touch buttons controls. Therefore, the application system co-operatively installed with the card reader according to the present invention needs not to be significantly modified in the hardware circuit design thereof; as a result, for an application system externally connected with a card reader, alternation or modification of hardware circuit design therein is not required, and the objective for integrated design of card reader as well as touch button control features can be achieved with ease, further providing advantages of reduction in product size and cost, too. Additionally, the card reader integrated with touch button control according to the present invention may be more conveniently and flexibly applied to various application systems.

The aforementioned illustrations have presented the detailed descriptions and drawings of the embodiments according to the present invention, but are not used to restrict the present invention. The scope of the present invention should be defined based on the subsequent claims, and all possible changes, alternations or modifications that skilled ones in relevant arts may conveniently consider are thus deemed to be encompassed within the scope of the present invention delineated by the claims set out hereunder.

What is claimed is:

1. A card reader integrated with touch button control, which is used in an application system, wherein the card reader comprises:
a touch sensing interface, which has plural touch buttons;
at least one memory card interface, which is used to connect a memory card; and
a control chip module, which is connected to the touch sensing interface and the memory card interface, and, in terms of the touch sensing interface and the memory card interface, it respectively uses a different specification of device class to build connections with the application system for performing signal transmissions.

2. The card reader integrated with touch button control according to claim 1, wherein the card reader is built-in, internally connected or externally connected to the application system.

3. The card reader integrated with touch button control according to claim 2, wherein the card reader further comprises an interface connection unit, used to connect to a system connection unit in the application system in an internally connected or externally connected approach.

4. The card reader integrated with touch button control according to claim 1, wherein the touch sensing interface uses a design of capacitive touch control interface.

5. The card reader integrated with touch button control according to claim 1, wherein the control chip module uses a design of Universal Serial Bus (USB) or PCI-Express chip module.

6. The card reader integrated with touch button control according to claim 5, wherein the PCI-Express control chip module further employs the USB transmission protocol to operate.

7. The card reader integrated with touch button control according to claim 5, wherein the control chip module, in terms of the touch sensing interface, uses a Human Interface Device (HID) class in the specification of USB to perform signal transmissions with the application system.

8. The card reader integrated with touch button control according to claim 5, wherein the control chip module, in terms of the memory card interface, uses a Mass Storage Device Class in the specification of USB to perform signal transmissions with the application system.

9. A control chip module of the card reader integrated with touch button control, wherein the card reader comprises a touch sensing interface, at least one memory card and an interface connection unit, in which the control chip module comprises:
a sensing unit, which generates a button sensing signal based on the status of the touch sensing interface;
a sensing control circuit, which is used to control the operation of the sensing unit;
a card interface unit, which is connected to the memory card interface for transmitting a data signal to a memory card inserted into the memory card interface;
a signal processing unit, which is connected to the interface connection unit so as to perform signal conversion and transmission with an application system; and
a Universal Serial Bus (USB) processing unit, which is used to control the actions of the card interface unit and the sensing control circuit in order to receive the data signal and the button sensing signal, and further respectively uses a different specification of device class to build connections with the application system for performing signal transmissions.

10. The control chip module of the card reader integrated with touch button control according to claim 9, wherein the touch sensing interface has plural touch buttons.

11. The control chip module of the card reader integrated with touch button control according to claim 9, wherein the USB processing unit, in terms of the button sensing signal, uses a Human Interface Device (HID) class in the specification of USB to perform signal transmissions with the application system.

12. The control chip module of the card reader integrated with touch button control according to claim 9, wherein the USB processing unit, in terms of the data signal, uses a Mass Storage Device Class in the specification of USB to perform signal transmissions with the application system.

13. The control chip module of the card reader integrated with touch button control according to claim 9, further comprises:
a voltage indication circuit, which is connected to the touch sensing interface and provides the status of the touch sensing interface to the sensing unit.

14. The control chip module of the card reader integrated with touch button control according to claim 13, wherein the voltage indication circuit and the sensing unit are of analog circuit design.

15. The control chip module of the card reader integrated with touch button control according to claim 13, further comprises:
a decoding circuit, which is connected to the sensing unit, and further decodes the button sensing signal for converting the button sensing signal from analog signal to digital signal.

16. The control chip module of the card reader integrated with touch button control according to claim 9, further comprises:
a memory unit, which is connected between the card interface unit and the signal processing unit and receives the control from the USB processing unit, used for registering and providing the data signal.

17. A control chip module of the card reader integrated with touch button control, wherein the said module is a multi-chip module, and card reader comprises a touch sensing interface, at least one memory card and an interface connection unit, in which the control chip module comprises:
a button control chip, which is connected to the touch sensing interface, used to generate a button sensing signal based on the status of the touch sensing interface; and
a card reading control chip, which is connected to the button control chip and further comprises:
a card interface unit, which is connected to the memory card interface for transmitting a data signal to a memory card inserted into the memory card interface;
a signal processing unit, which is connected to the interface connection unit so as to perform signal conversion and transmission with an application system; and
a USB processing unit, which controls the actions of the card interface unit and the sensing control circuit in order to receive the data signal and the button sensing signal, and also further uses the Mass Storage Device Class in the specification of USB for performing signal transmissions with the application system, and alternatively uses a Human Interface Device (HID) class to transfer the button sensing signal with the said application system.

18. The control chip module of the card reader integrated with touch button control according to claim 17, wherein the button control chip is connected to the card reading control chip through an I2C connection.

19. The control chip module of the card reader integrated with touch button control according to claim 17, wherein the touch sensing interface has plural touch buttons.

20. The control chip module of the card reader integrated with touch button control according to claim 17, further comprises:
a memory unit, which is connected between the card interface unit and the signal processing unit and receives the control from the USB processing unit, used for registering and providing the data signal.
